(19) United States
(12) Patent Application Publication
(10) Pub. No.: US 2006/0260560 A1
(43) Pub. Date: Nov. 23, 2006

(54) Animal rope and plush toy

(76) Inventors: Jack W. Renforth, Aurora, CO (US); Martin Caveza, Redondo Beach, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/190,353

(22) Filed: Jul. 26, 2005

Related U.S. Application Data
(60) Provisional application No. 60/684,243, filed on May 23, 2005.

(51) Int. Cl. A01K 29/00

(52) U.S. Cl. 119/707

(57) ABSTRACT

An animal toy having a body, a rope extending through said body from an entry point to an exit point, and an object external to the body, the rope at least partially extending through the object. The body may be a plush body. The body may further be affixed to either the rope or the object. The object may be, for example, a ball. The rope may pass through the ball, or may terminate in a knot inside the ball. The rope may form a loop passing through the ball or other object. The rope may be affixed to the ball or object, or may freely pass therethrough.

### CROSS-REFERENCE TO RELATED APPLICATIONS

This application claims the benefit under 35 U.S.C. § 119(e) of provisional patent application No. 60/684,243, filed on May 23, 2005 and entitled “Animal Rope and Plush Toy”, the disclosure of which is hereby incorporated herein in its entirety.

### BACKGROUND OF THE INVENTION

1. Technical Field

The present invention relates generally to toys, and more specifically to an animal toy.

2. Background Art

Many toys have been used to entertain animals. For example, animals (and particularly dogs) often enjoy tugging or pulling on a length of rope. Some toys attach various objects to the rope, or thread the rope through objects to increase the appeal of the toy as well as provide gripping surfaces. Certain toys attach the rope directly to the object. For example, a rope may terminate inside a ball in a knot retaining the rope therein, or may be stitched directly to the ball.

In either case, the life of the toy is limited by the stresses exerted on the object when the rope is pulled taut. Repeated pulling or tugging on the rope, especially when the rope is affixed to the object, may cause the object to break or the attachment between rope and object to come undone. This ultimately results in the destruction of the toy.

Animals often enjoy playing with, chewing on, or pulling on plush toys as well. Many plush toys are designed to withstand chewing, but not necessarily a tugging or pulling force. Such forces may stretch the stitching holding the plush toy together, especially where the force is exerted directly on the plush toy or the junctions between portions of the toy. Thus, plush toys also often fall apart when repeatedly tugged or pulled.

Accordingly, there is a need in the art for an improved animal toy.

### BRIEF SUMMARY OF THE INVENTION

One embodiment of the present invention takes the form of an animal toy having a body, a rope extending through said body from an entry point to an exit point, and an object external to the body, the rope at least partially extending through the object. The body may be a plush body. The body may further be affixed to either the rope or the object. The object may be, for example, a ball. The rope may pass through the ball, or may terminate in a knot inside the ball. The rope may form a loop passing through the ball or other object. The rope may be affixed to the ball or object, or may freely pass therethrough.

Another embodiment of the present invention takes the form of an animal toy having a plush body and a rope passing therethrough. The toy may include a ball, cylinder, or other object at one end, although this is optional. Generally, a first end of the rope extends from a first end of the plush body, and a second end of the rope extends from a second end of the plush body. Pulling the rope taut generally exerts no stresses on the plush body or its attachment points with either the object or rope.

Additional features and advantages of the present invention will become apparent upon reading the entirety of this disclosure.

### BRIEF DESCRIPTION OF THE FIGURES

FIG. 1 depicts a top view of a first embodiment of the present invention.

FIG. 2 depicts a side view of the embodiment of FIG. 1.

FIG. 3 depicts the embodiment of FIGS. 1 and 2, with a portion of the embodiment drawn taut.

FIG. 4 depicts a top view of a second embodiment of the present invention.

FIG. 5 depicts a partial side view of the embodiment of FIG. 4.

FIG. 6 depicts an isometric view of a third embodiment of the present invention.

FIG. 7 depicts a top view of the embodiment of FIG. 6.

### DETAILED DESCRIPTION

One embodiment of the present invention takes the form of an animal toy having a plush body and a rope passing therethrough. The toy may include a ball, cylinder, or other object at one end, although this is optional. Generally, a first end of the rope extends from a first end of the plush body, and a second end of the rope extends from a second end of the plush body.

In alternative embodiments, one or both ends of the rope may be formed into a loop. At least a portion of the loop is exposed (i.e., outside the plush body). In some embodiments, the entire loop (or loops) may be exposed. Portions of the loop may pass through the plush body, or an unlooped segment of the rope may pass through the plush body.

Regardless, in many embodiments the rope and plush body are affixed to one another, typically by stitching. Alternative embodiments, however, may affix rope and plush to one another with adhesive, staples, or any other conventionally-known fastener. The plush body and rope are affixed to one another such that tugging, pulling, or otherwise exerting stresses on the rope does not exert stress on the plush body (beyond incidental stresses). That is, pulling on both ends of the rope does not, for the most part, pull on, or exert force on, the body. This occurs for two reasons. First, the rope passes entirely through the body. Thus, the rope may conduct forces from the first end to the second end directly, or vice versa. Second, the attachments between the rope and plush body generally are not planar with the longitudinal axis of the rope. Accordingly, as the rope is pulled taut, the resulting force vector extends along the rope's longitudinal axis and is not transmitted to the plush body. In this manner, the attachments or connections between the plush body and rope do not fray or snap as readily, and the toy maintains its structural integrity for a longer time.

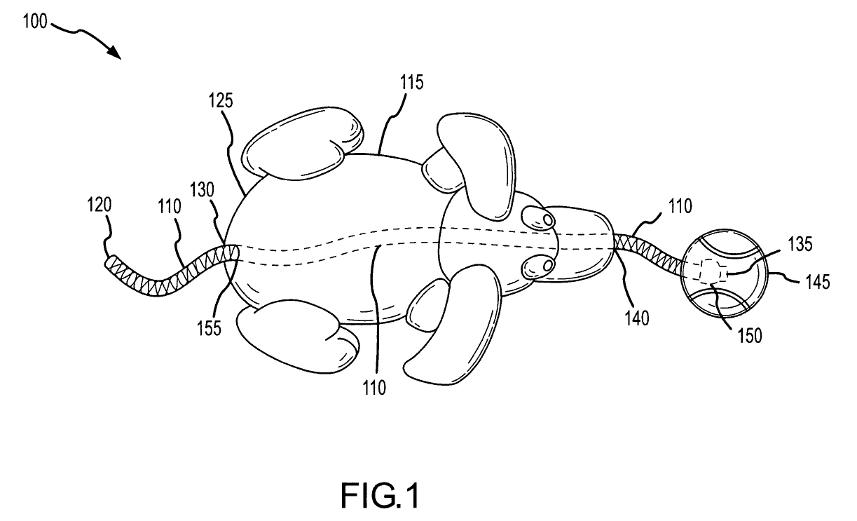

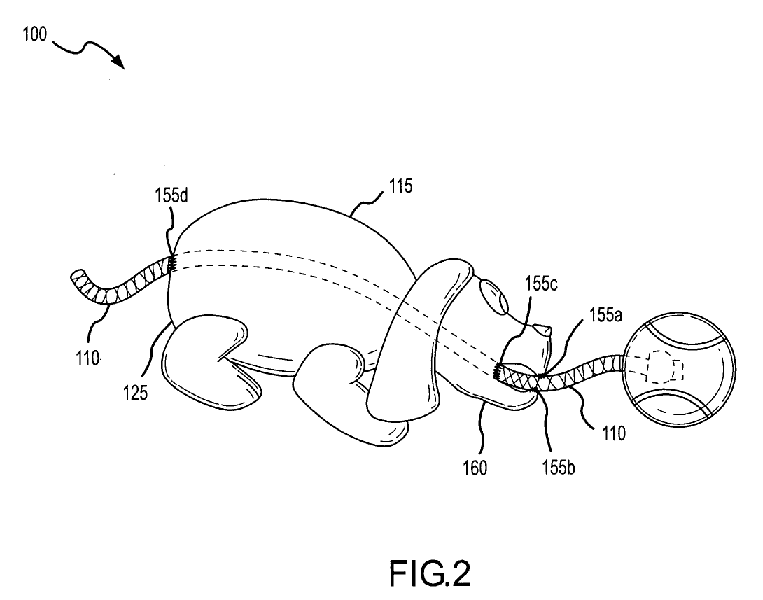

FIG. 1 depicts a top-down view of a first embodiment 100 of the present invention. As shown, a rope 110 passes through a plush body 115. A first end 120 of the rope 110 protrudes from a first end 125 of the plush body 115, entering the body at an entry point 130. A second end 135 of the rope 110 exits from the body 115 at an exit point 140, and ultimately is concealed within a ball 145 or other object affixed to the second end 135. The rope 110 may terminate in a knot 150 within the ball 145, for example. Alternative embodiments may use a cylinder, cube, or other object instead of a ball 145. The dashed lines in FIGS. 1 and 2 depicts portions of the rope 110 hidden from view by the plush body 115 and/or ball 145. Generally speaking, the length of rope 110 inside the plush body 115 is approximately equal to the distance between the entrance 130 of the rope 110 into the plush body 115 and the exit 140 of the rope 110 from the plush body 115. In alternative embodiments, the first end 120 of the rope 110 may be concealed within the plush body 115. Such embodiments would therefore lack an entry point 130.

The plush body 115 is secured to the rope 110 at least one attachment point 155. Typically, the plush body 115 is stitched to the rope 110 at the attachment point 155. Alternatively, the rope 110 and plush body 115 may be glued together at the attachment point 155 or otherwise affixed. FIG. 2, for example, depicts the embodiment 200 and associated attachment points 155a, 155b, 155c, 155d from a side view. As shown, the rope 110 is affixed to the plush body 115 at three points at the second end 160: the top jaw 155a of the plush body 115, the bottom jaw 155b of the plush body 115, and the interior of the plush body jaw 155c, where the rope 110 enters the plush body 115. Similarly, the rope 110 may be secured at the first end (rear) 125 of the plush body 115 where it exits the body 115, shown as 155d.

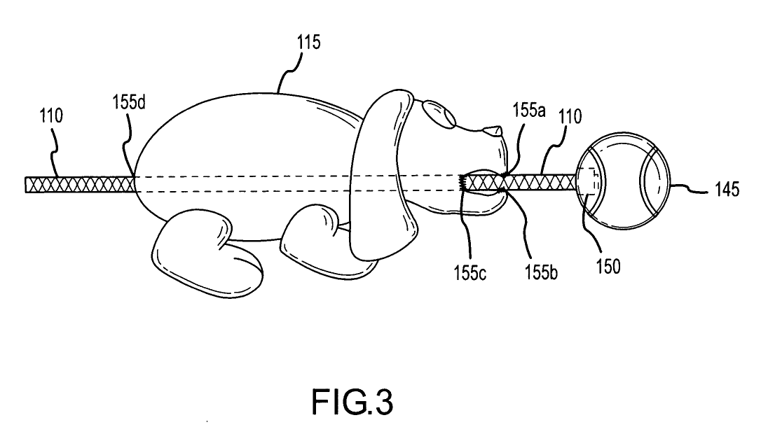

FIG. 3 depicts the embodiments of FIGS. 1 and 2 with the rope 110 drawn taut. In this view, the rope 110 extends in a relatively straight line. Because the location of the attachment points 155a, 155b, 155c, 155d along the rope 110 do not change, and the length of rope 110 inside the plush body 115 equals the distance between attachment points (155a, 155b, 155c, and 155d), pulling the rope 110 taut does not exert stress (other than incidental stresses) on the plush body 115. It should be noted that the rope 110 is retained inside the ball 145 by the knot 150 therein.

As shown to best effect in FIG. 1, the rope 110 passes entirely through the plush body 115 and is a single element. The rope 110 thus maintains its structural integrity within the body 115. Accordingly, when the rope 110 is pulled taut by exerting opposing forces at each end (120 and 130) of the rope 110, the opposing forces are not transmitted to the plush body 115. Both ends of the rope 110 may be pulled on by holding the first end of the rope 120 and tugging on the ball 145 containing the second rope end 135, for example.

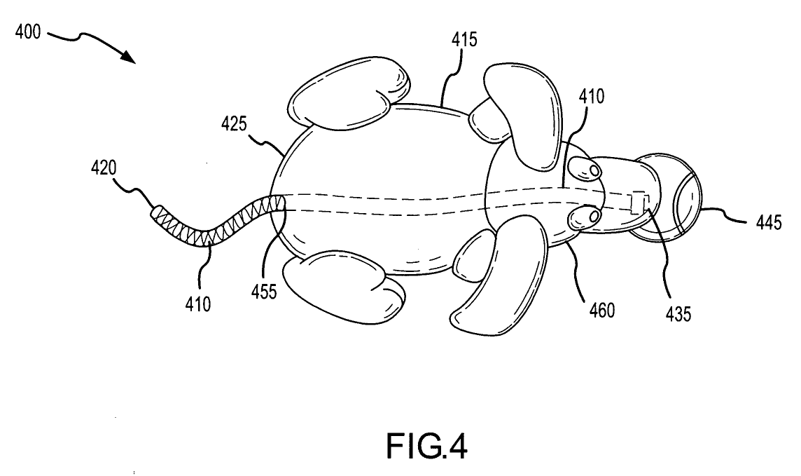

FIG. 4 depicts another embodiment 400 of the present invention. This embodiment is identical to that shown in FIGS. 1 and 2, except the second end 460 of the plush body 415 is secured to the ball 445 instead of the rope 410. The first end 420 of the rope 410 still projects from the first end 425 of the body 415. The second end 435 of the rope 410 is concealed within the ball 445. As above, the second end 435 of the rope 410 may alternatively project from the ball 445.

One may draw the rope 410 taut by holding the ball 445 and pulling the rope's first end 420. Although the rope 410 is secured to the plush body 415 at an attachment point 455, the attachment point 455 does not lie along the force vector. Thus, at most only incidental stresses are exerted on the attachment point 455 and/or plush body 415 when the rope 410 is tugged or tautened.

In addition to relieving stress on the plush body 415, which is typically more sensitive to stresses than the rope 410, the various embodiments of the present invention combine a number of elements or objects with which many animals like to play. As mentioned above, some embodiments of the invention combine a plush animal, a rope, and a ball. Each of these items individually is used to entertain and distract animals, such as dogs. It is believed the combination of such items may prove particularly entertaining to animals.

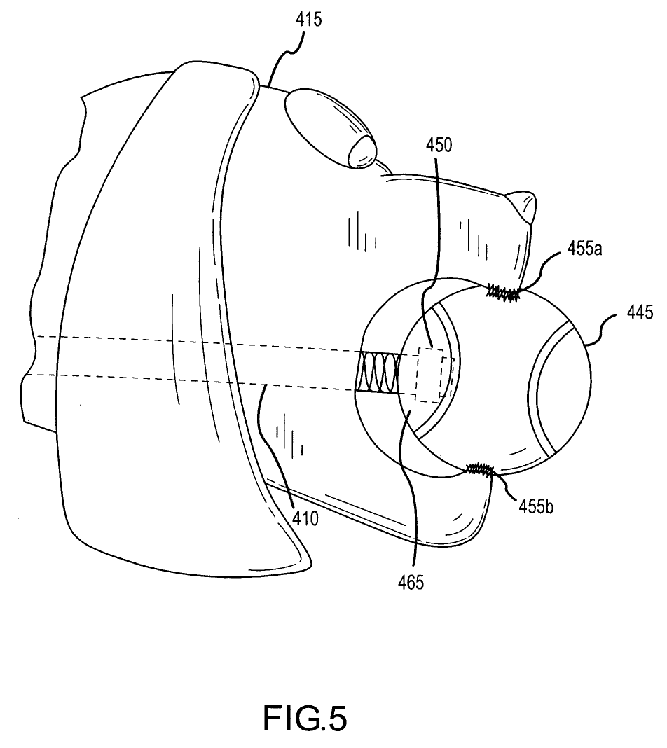

FIG. 5 depicts another view of the embodiment FIG. 4. In this embodiment, the plush body 415 is secured to the ball 445 or other object at an end, rather than the rope 410. The body 415 may be secured at the opposing end to the rope 410. FIG. 5 depicts a partial side view of the plush body 415, rope 410, and ball 445 shown in FIG. 4, more clearly showing the attachment points 455a and 455b between ball 445 and plush body 415. Again, the rope 410 may extend not only through the plush body 415, but also through the ball 445 such that the rope's second end 435 is outside the ball 445. A knot 450 or retaining element may hold the rope 410 within the ball 445 or outside the ball 445.

As with the previously-discussed embodiment, tugging on the ball 445 and rope 410 to pull the rope 410 taut does not project appreciable stress onto the plush body 415. Although the ball 445 is affixed to the plush body 415, the stress is generally carried by the junction of ball 445 and rope 410. The knot 450 comes to rest against the sidewall of the ball 465, while the rope's other end (first end, not shown) is pulled tight to transmit force to the ball 445. In any of the embodiments discussed herein, the rope 410 may be unattached to the plush body 415 at either the first or second ends to permit the rope 410 to slide through the body 415, either partially or completely.

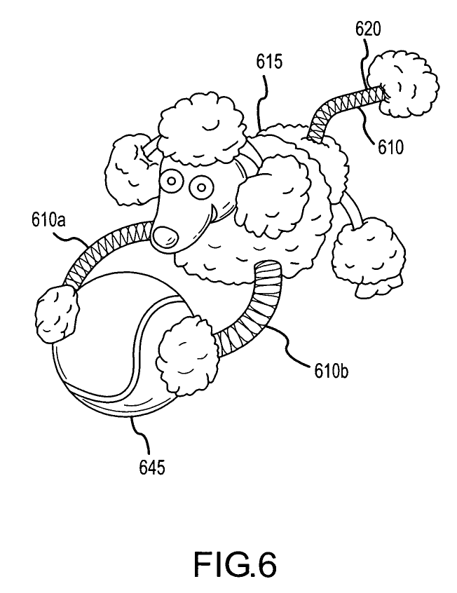

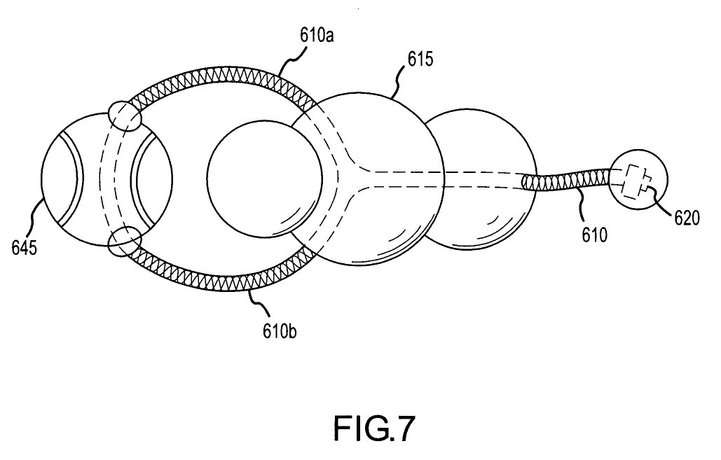

FIGS. 6 and 7 depict yet another embodiment of the present invention. As shown in isometric view in FIG. 6 and overhead, simplified view lacking adornments in FIG. 7, the rope 610 projects from the plush body 615 at its first end 620 as discussed above. However, the rope 610 splits into two strands (610a and 610b) inside the plush body (shown to best effect in FIG. 7, where again dashed lines indicate portions of the rope hidden from view). The rope strands 610a, 610b exit the plush body 615 in two places to form the “arms” of the overall toy, as shown to best effect in FIG. 6. The strands meet inside the ball portion 645 of the embodiment, forming a single loop. Each strand is effectively a continuation of the other. The rope 610 may or may not be attached to the plush body 615 at its entrance and exit points.

It should be understood that FIG. 7 is a simplified, schematic version of the embodiment shown in FIG. 6, with much of the detail removed therefrom to more clearly illustrate the relationship between the rope 610, body 615, and ball 645. The exact shape of the plush body 615 may vary in any of the embodiments discussed herein. Further, although the body 615 is referred to as being “plush,” it may be constructed of any suitable fabric, whether plush or not. The body 615, for example, may be made from a fabric, rubber, or plastic. Similarly, the rope may be made of any suitable materials such as hemp, fiber, plastic, metal links, or other man-made materials.

Additional embodiments may form the rope into a loop at both ends, instead of only at a single end. The rope may thus take the form of a figure-eight or Moebius strip. The looped portion of the rope 610 may exit the plush body 615 at two points (as shown in FIGS. 6 and 7), or the rope may exit at a single point, in which case the T-junction of the loop is outside the body.

Although the present invention has been discussed with respect to specific embodiments, those of ordinary skill in the art will appreciate that additional embodiments may be realized upon review of the foregoing disclosure. Similarly, certain changes to the various embodiments described herein may occur to those of ordinary skill in the art upon reading the disclosure. Accordingly, the proper scope of the invention is defined by the appended claims.

We claim:

1. An animal toy, comprising:
a body;
a rope extending through said body from an entry point to an exit point; and
an object external to the body, the rope at least partially extending through the object.

2. The animal toy of claim 1, wherein the rope terminates within the object.

3. The animal toy of claim 2, wherein the rope terminates in a knot within the object, the knot retaining a first end of the rope within the object.

4. The animal toy of claim 1, wherein the rope extends fully through the object.

5. The animal toy of claim 4, wherein the rope forms a loop, at least a portion of the loop passing through the object.

6. The animal toy of claim 5, wherein:
the loop attaches to a second segment of the rope at a junction; and
the junction is concealed within the body.

7. The animal toy of claim 6, wherein the second segment of the rope forms a second loop.

8. The animal toy of claim 1, wherein the body is a plush body.

9. The animal toy of claim 1, wherein the object is a ball.

10. The animal toy of claim 1, wherein the body is affixed to the object at a first attachment point.

11. The animal toy of claim 10, wherein the body is further affixed to the object at a second attachment point.

12. The animal toy of claim 11, wherein the body is stitched to the object at the first and second attachment points.

13. The animal toy of claim 11, wherein the length of rope within the body is equal to the distance between the entry point and exit point.

14. The animal toy of claim 13, wherein puling the rope taut exerts only incidental stresses on the body.

15. The animal toy of claim 1, wherein puling the rope taut exerts only incidental stresses on the body.

16. The animal toy of claim 1, wherein the body is affixed to the rope at an attachment point.

17. An animal toy, comprising:
a body;
a rope at least partially extending through said body, the rope exiting the body at an exit point; and
an object external to the body, the rope at least partially extending through the object.

18. The animal toy of claim 17, wherein the rope extends fully through said body, the rope entering the body at an entry point.
